(19) United States
(12) Patent Application Publication
(10) Pub. No.: US 2025/0178812 A1
(43) Pub. Date: Jun. 5, 2025

(54) PACKAGING FOR THE PRESENTATION AND STORAGE OF CULINARY PREPARATION PORTIONS

(71) Applicant: MOF-MINIATURE ORIGINAL FOOD, La Ferté-Bernard (FR)

(72) Inventor: William WINDYS, La Ferté-Bernard (FR)

(21) Appl. No.: 18/846,096

(22) PCT Filed: Mar. 13, 2023
(86) PCT No.: PCT/EP2023/056285

§ 371 Date: Sep. 11, 2024

Related U.S. Application Data
(60) Provisional application No. 63/325,849, filed on Mar. 31, 2022.

(30) Foreign Application Priority Data
Mar. 11, 2022 (FR) FR2202178

(51) Int. Cl. B65D 77/04; B65D 65/46

(52) U.S. Cl. CPC B65D 77/046; B65D 65/466; B65D 2203/06; B65D 2401/05; B65D 2577/043

(57) ABSTRACT

A packaging for storing and presenting culinary preparations in the form of a series of unit portions. The packaging includes: a main base made of a biodegradable material based on sugar cane pulp, having a first bottom and a first flange extending from a periphery of the first bottom; a plurality of secondary bases intended to be placed in the main base and each adapted to receive one of the unit portions, made of a biodegradable material based on sugar cane pulp and each having a second bottom and a second flange extending from the periphery of the second bottom, at least the second bottom being covered with a tight biodegradable coating; and a cover for the protection and storage of the culinary preparation portions, adapted to fit onto the main base.

### FIELD OF THE INVENTION

The field of the invention is that of storage, conservation and presentation of elaborated culinary preparations, in the form of unit pieces. More particularly, the invention relates to a packaging suited to such culinary preparation pieces, for example nibbles, morsels or portions of a ready meal, etc.

### PRIOR ART

Such culinary preparations are often produced by caterers, and supplied by these on trays, for immediate consumption. In this case, no solution is provided for long-term conservation, transport and storage, or quality presentation, in particular for elaborated products.

For example, it is not contemplated to provide such preparations in transportation means, for example in airplanes, or on request, for example in a restaurant, without having to call upon a cooker, to prepare them, put them up and present them.

Moreover, in the field of food product packagings, numerous solutions allowing for example the commercialisation in the mass-retail sector, are known.

In particular, packagings in the form of a case comprising a container covered with a removable or articulated cover in which it is possible to store food products in a substantially orderly manner are known.

In general, these cases are made of plastic such as polypropylene (PP), polyethylene terephthalate (PET), polystyrene (PS), expanded polystyrene (EPS), high-density (HDPE) or low-density (LDPE) polyethylene or polyvinyl chloride (PVC).

In order to improve the storage of food products, in particular when these consist of delicate culinary preparations, some cases implement a support subplate made of plastic. These support bases may have cells adapted to receive and order the products. For example, these support bases are used for packaging relatively delicate nibbles, such as macaroons.

One drawback of this solution lies in that the case and/or the support subplate cannot be used for heat-up at temperatures higher than 120° C. Hence, it is necessary to use plastics that are more heat-resistant, and therefore more expensive.

Another drawback of this solution lies in that the manufacture of the container, of the cover and of the subplate sometimes requires the use of different materials for each of these elements, bearing in mind that these different materials are not always compatible with selective sorting or having different recycling modalities. Hence, it is difficult for the user to properly recycle these elements.

Hence, this solution is not satisfactory, in particular because these packagings are disposable, i.e. intended for one single use. Besides, most of the packagings currently used are not biodegradable and therefore have a considerable environmental impact when they are not properly recycled.

Still another drawback is that the presentation of the products is done, at best, via a subplate serving as a tray, with a poor quality and barely practical in use. Of course, the user could displace the portions one after another on a tray or a dish, but such a manipulation is long and somehow unhygienic, because of the possible contact between the hand and the product.

There is also known the use of waxed paper to pack or only to serve as an individual presentation support for each food product portions. In particular, the use of such paper allows avoiding sticking of the culinary product to the case in which the food products are disposed.

One drawback of this solution lies in that the presentation of the food products in the case is not aesthetically pleasant, even when the paper is shaped (for example when it is corrugated or pleated at its periphery). The same applies to the overall presentation of the packaging, for example when the latter is disposed one the shelf of a store. This is actually a recurrent drawback of known packagings for storing and presenting culinary products.

Another drawback lies in that the transport of the food product packagings is not always simple, in particular because of the particular shape of some of these packagings and of the portions, and of the nature, somehow elaborated, for example into several layers.

Hence, there is a need for providing a new solution for packaging culinary portions that is ecological, simple to use, aesthetically pleasant, ecological, which allow for a good conservation and an easy transport, in particular for elaborated culinary products, of high quality and consequently requiring an optimum and original presentation, while not needing, at the time of presentation and preparation just before this presentation, the intervention of a specialist, in particular a caterer or a cooker. Hence, the invention should also allow for an easy heat-up of the culinary preparations where necessary.

### SUMMARY OF THE INVENTION

The technique of the invention allows solving at least some of the drawbacks raised by the prior art. More specifically, the invention relates to a packaging for the storage and presentation of culinary preparations in the form of a series of unit portions.

According to the invention, the package comprises:
a main base made of a biodegradable material based on sugar cane pulp, having a first bottom and a first flange extending from the periphery of said first bottom;
a plurality of secondary bases intended to be placed in said main base and each adapted to receive one of said unit portions, made of a biodegradable material based on sugar cane pulp and each having a second bottom and a second flange extending from the periphery of said second bottom, at least said second bottom being covered with a tight biodegradable coating;
a cover for the protection and storage of the culinary preparation portions, adapted to fit onto said main base.

The dimensions of said main base and of said cover are defined so that they can receive said plurality of secondary bases according to a unique line.

Thus, there is provided an original and innovative packaging, which is particularly suited for the conservation and the presentation of elaborated culinary preparations and completely biodegradable.

According to one aspect of the invention, said cover has a truncated pyramid shape.

This allows facilitating stacking and storage of a cover set, and confers a high-end appearance on the packaging.

According to another aspect of the invention, the packaging comprises a transparent protection made of a biodegradable material fitting onto said secondary bases.

Such a transparent protection, intended to be affixed on a secondary base, allows avoiding the transfer of flavours between two adjacent culinary preparation portions. The transparent protection also allows improving the conservation of the culinary preparation. It is also involved in the protection of the culinary preparation against the external environment (for example: insects; contact by the consumer . . . ) in particular when the packaging is used/presented on a reception buffet. The transparent protection also allows presenting the culinary preparation portion on its secondary base. The transparent protection may also allows keeping the culinary preparation at constant temperature after heat-up.

According to a particular aspect of the invention, said tight biodegradable coating may be recycled polyethylene terephthalate (RPET).

The implementation of recycled polyethylene terephthalate, which is a laminated material, allows avoiding the transfer of matter between the secondary base and the culinary preparation portion. Such a material is compatible with heat-up in the oven and conservation by freezing. This biodegradable and compostable material also avoids that the culinary preparation portion does not stick to the secondary base.

According to another particular aspect of the invention, the first bottom of said main base and the second bottoms of said secondary bases may be substantially rectangular or square.

Such a shape allows for an optimum holding of the culinary preparation in the packaging. It also facilitates the assembly of the covers and of the transparent protections on the main bases and the secondary bases, respectively. The storage of a plurality of packagings by superimposition/stacking is also facilitated. To finish, this shape is particularly suited for delivery or for use in airplanes/boats, in particular.

According to still another particular aspect of the invention, the packaging may bear a unique identification code of said culinary preparation(s) stored and presented in said packaging.

In particular, the implementation of such a code allows for an optimum traceability of the culinary preparations.

In particular, said identification code and/or a second code may be configured in the form of an image readable and interpretable by suitable electronic means, to enable the obtainment of information relating to the or to said culinary preparation portion(s) stored and presented in said packaging.

Such a code, for example of the QR-code type, allows providing accurate information on the culinary preparation portions stored and presented in the packaging, such as the identifier of the product, its recipe, the nutritional information, the allergens, etc., its technical datasheet (heat-up time, conservation, etc.). This code allows for an optimum consumption of the culinary preparations stored in said packaging.

According to another particular aspect of the invention, said information may belong to the group comprising:
information on the culinary preparation(s) contained in the packaging;
information on the manufacture and the origin of the culinary preparation(s) contained in the packaging;
information on the conservation and expiration of the culinary preparation(s) contained in the packaging;
information on the use, in particular the heat-up, of the culinary preparation(s) contained in the packaging.

According to another aspect of the invention, the packaging may comprise a rectangular parallelepipedic overpackaging into which the packaging is intended to be inserted and extracted by one of the small sides of the parallelepipedic overpackaging.

Such an overpackaging facilitates storage and transport. It also allows facilitating the presentation and storage of the packaging according to the invention on product sale shelves. Such an overpackaging is particularly adapted to facilitate the use of the packaging in airplanes/boats/trains or for deliveries, in particular.

In particular, said overpackaging may be sealed using a single-use securing element proving that the packaging has not been opened.

This securing element ensures an optimum storage, by limiting the risks of undesired opening of the overpackaging. The securing element, for example in the form of a ring, also allows guaranteeing the traceability of the culinary preparation(s) contained in the packaging inserted into the overpackaging.

According to another particular aspect of the invention, said cover may comprise at least one stop configured to enable a controlled sacking of several covers for the storage of these.

The implementation of this stop facilitates the storage, the transport of the empty packaging (i.e. without a culinary preparation portion) and the detachment of the stacked covers.

According to a particular aspect of the invention, the packaging may be configured to withstand high temperatures, namely at least 240° C., and very low temperatures, namely at least −180° C.

Thus, the packaging of the invention is adapted to enable an optimum conservation in the freezer or in the refrigerator, as well as a cryogenic treatment. It is also adapted to enable a heat-up or a baking of the culinary preparation(s) in an oven, for example.

### LIST OF THE FIGURES

The invention, as well as the different advantages it has, will be more easily understood, from the following description of an illustrative and non-limiting embodiment thereof, and from the appended drawings amongst which:

FIG. 1 is a perspective view illustrating a main base and a cover of a packaging in accordance with the invention;

FIG. 2 is a longitudinal sectional view illustrating the main base and the cover of FIG. 1;

FIG. 3 is a perspective view illustrating a packaging in accordance with the invention;

FIG. 4 is a perspective view illustrating a secondary base and an optional protection intended to be received in the main base and the cover of FIGS. 1 to 3;

FIG. 5 is a longitudinal sectional view illustrating the secondary base and the protection of FIG. 4;

FIG. 6 is a perspective view of an empty and open overpackaging into which the packaging according to the invention is intended to be inserted; and

FIG. 7 is a perspective view of a closed overpackaging into which the packaging according to the invention has been inserted; and

FIG. 8 is a perspective view of another example of a packaging according to the invention.

### DETAILED DESCRIPTION OF THE INVENTION

The general principle of the invention is based on the implementation of a plurality of elements made of biodegradable materials, for a packaging for the presentation and storage of culinary preparation portions.

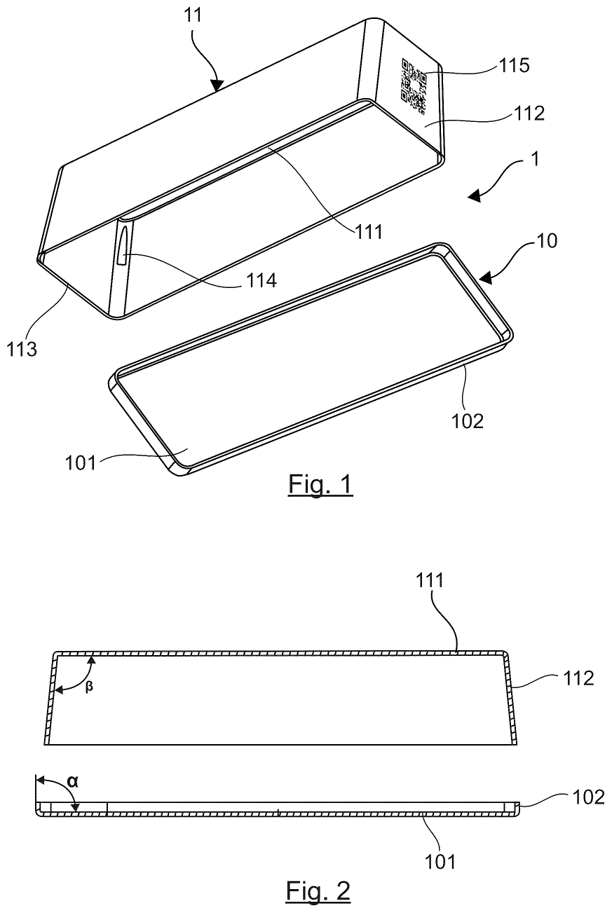

FIGS. 1 and 2 partially illustrate an example of a packaging 1 in accordance with the invention.

In particular, such a packaging 1 comprises an elongate main base, or tray, 10 and a cover 11 intended to cover the central base 10. The central base 10 and the cover 11 are made of sugar cane pulp, which is a biodegradable and recyclable material. Hence, such a packaging has a very low environmental impact.

Furthermore, such a material is adapted to withstand high temperatures, in particular higher than 240° C., in order to enable a heat-up of the culinary preparations before consumption, for example in an oven. Hence, during heating at such temperatures, such a material avoids a transfer of flavours or deterioration thereof.

Furthermore, such a material is also adapted to withstand very low temperatures, in particular lower than −180° C. Thus, the culinary preparation portions stored within the packaging in accordance with the invention could be easily conserved. They could also be frozen directly in their packaging, and undergo a cryogenic treatment.

The main base 10 has a substantially rectangular shape.

The main base 10 comprises a bottom 101 as well as a flange 102 extending from the bottom wall 101, and over the entire periphery of the bottom wall 101. This flange may be perpendicular to the bottom or, preferably, form an angle substantially larger than 90° with the latter.

More specifically, according to the illustrated embodiment, the flange forms with the bottom an angle α of about 92°, as illustrated in FIG. 2 which is a longitudinal sectional view of the cover 11 and of the main base 10. Such an angle enables stacking of several main bases 10 when these are not used for the presentation and storage of culinary preparation portions. Thus, a controlled stacking of the main bases 10 is allowed, for storage before and after use. The separation of the main bases 10 is also facilitated by this slightly obtuse angle.

Such a flange 102 also allows holding the position of the cover 11 on the main base 10. Indeed, the dimensions of the cover 11 and of the main base 10 are adapted so that the cover 11 is affixed on the main base 10 without the latter being able to move, in rotation and in translation in particular, relative to the main base 10.

The cover 11 is substantially shaped like a truncated pyramid, having a bottom wall 111 extended, over its periphery, by a lateral wall 112 extending in an inclined manner with respect to the bottom wall 111. More specifically, the lateral wall 112 is inclined according to an angle β of about 95°, as illustrated in FIG. 2 which is a longitudinal sectional view of the cover 11 and of the main base 10.

The end of the lateral wall 112 of the cover 11 opposite to the bottom wall 111 forms an edge 113 having a general shape corresponding the bottom wall 101 of the main base 10. As indicated hereinabove, the lateral wall 112 has, at its edge 113, dimensions adapted so that the cover 11 cooperates with the central base 10.

As illustrated in FIG. 1, the angles of the lateral wall 112 have stops 114 which allow for an easy and optimum stacking of the covers 11 when these are not used to cover a main base 10 and the culinary preparation portions contained thereby. Thus, the stops 114 allow for a controlled stacking of the covers 11 so as to promote storage thereof. The stops 114 also enable the covers not to be stacked too deeply into each other in order to facilitate separation thereof.

In this example, each angle, or corner, of the lateral wall 112 has such a stop 114. Nonetheless, it could be contemplated to implement only two stops 114, for example at opposite corners. It should be easily understood that could also be contemplated to implement stops 114 at other locations along the lateral wall 112, on the face directed towards the inside of the cover 11.

As illustrated in FIG. 1, the packaging 1 bears an identification code 115, herein affixed on the cover. This identification code 115 is unique and allows for an optimum/complete traceability of the culinary preparations presented and stored in the packaging. The identification code 115 may be positioned otherwise on the packaging 1, provided that it is easily accessible.

For example, the unique identification code 115 is in the form of a barcode or a QR code (“Quick Response Code”). This unique identification code 115 allows obtaining, besides the traceability information, various information on the culinary preparation(s) conserved in the packaging 1.

For example, such an identification code 115 could allow retrieving different information, such as the identifier/the commercial name of the culinary preparation(s), the recipe, the nutritional information, the allergens or information relating to the preparation/consumption of the culinary preparations, such as the conservation temperature, the heat-up optimum conditions or the use-by date.

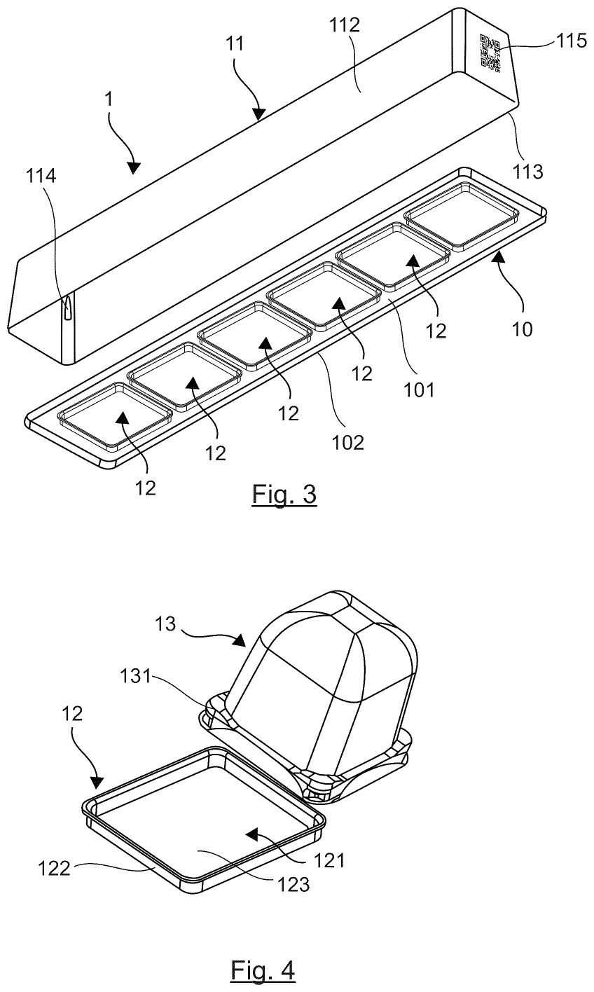

FIG. 3 illustrates another example of a packaging 1 in accordance with the invention. The main base 10 as well as the cover 11 are substantially identical to the main base and to the cover described hereinabove with reference to FIGS. 1 and 2. The main base 10 and the cover 11 of FIG. 3 differ from the main base and the cover of FIGS. 1 and 2 only in that their dimensions are different.

This FIG. 3 illustrates an essential aspect of the invention. Indeed, according to the invention, the packaging 1 receives a plurality of secondary bases 12 intended to be disposed on/in the main base 10, as illustrated in FIG. 3. Each of these secondary bases 12 is intended to receive a culinary preparation unit portion (not illustrated).

The dimensions of the secondary bases and of the main base are adapted so that the unit portions, and therefore the secondary bases, are presented in an aligned manner, so as to be easily presentable and consumable. In some cases, all portions are identical. In other cases, they may be different, and correspond for example to a succession of dishes, where appropriate from appetisers to desert. This approach is interesting in particular for consumption by one single person, for example in an airplane or in his hotel room.

The secondary bases 12 are made of sugar cane pulp, which is a biodegradable and recyclable material. Hence, such a packaging has a very low environmental impact. Moreover, such a material is adapted to withstand high temperatures and low temperatures, as described before. Hence, such a material is compatible with the intended use of such a packaging.

According to the invention, the upper face 123 of the bottom wall 121 of each secondary base 12 is covered with a coating made of a tight biodegradable material. More specifically, the upper face 123 is the face of the bottom wall intended to receive, i.e. to be in contact with, the culinary preparation.

The implementation of this tight additional coating is essential for the presentation and conservation of the culinary preparation, and allows in particular ensuring an optimum presentation (absence of blots or leakages of food products), and facilitates the detachment of the portion, upon consumption.

Preferably, the material covering the upper face 123 is recycled polyethylene terephthalate (RPET). Such a material is compatible for use with food products and withstands high temperatures (higher than 240° C.) and low temperatures (lower than −180° C.).

Such a material allows protecting the secondary base 12 from moisture and therefore avoids an undesired degradation of the secondary base 12, in particular during heat-up of the culinary preparation.

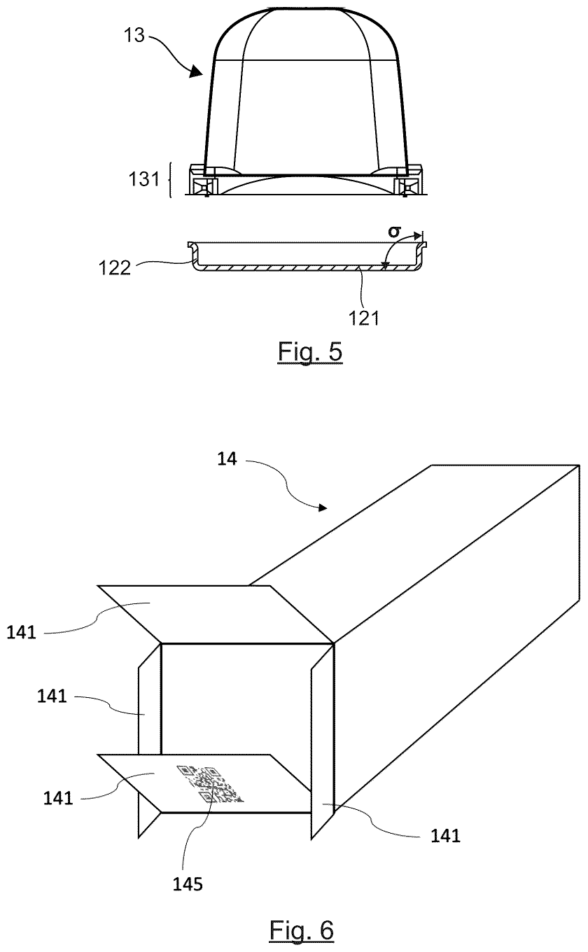

A secondary base 12 is illustrated in more details in FIGS. 4 and 5. Optionally, each secondary base 12 may be covered by a protective cap, or shell, 13, preferably transparent, which allows individualising and protecting the culinary preparation portion present on each secondary base 12 before consumption.

In the example illustrated in these figures, the secondary base 12 has a substantially square shape. Of course, it should be understood that the secondary base 12 could also have a substantially rectangular shape, in particular. The shape and the dimensions of the secondary base 12 are defined so as to correspond with the shape and the dimensions of the main base 10. Indeed, the secondary bases 12 are disposed in the main base 10 such that they are placed against each other in order to prevent a movement of these in the main base 10, in particular during transport. In other words, the secondary bases 12 are wedged against each other in the main base 10.

The secondary base 12 comprises a bottom 121 as well as a flange 122 extending substantially perpendicularly to the bottom wall 121, and over the entire periphery of the bottom wall 121.

More specifically, the flange 122 is inclined according to an angle σ of about 92°, as illustrated in FIG. 5 which is a longitudinal sectional view of the secondary base 12 and of the protective cap 13. Such an angle of inclination enables a stacking of several secondary bases 12 when these are not used for the presentation and storage of the culinary preparation portions. Thus, a controlled stacking of the secondary bases 12 is obtained. Such a flange 122 also allows optimally centring and holding each culinary preparation portion in the secondary base 12.

The protective shell 13, also called protection in the following description, is preferably made of a transparent material in order to allow identifying the culinary preparation stored and presented in the associated secondary base 12 easily. Furthermore, the implementation of a transparent protection provides an aesthetically pleasant presentation of the culinary preparation.

The transparent protection 13 is substantially in the form of a truncated pyramid extended by a dome. Of course, other shapes may be contemplated without departing from the principle of the invention.

Preferably, the transparent protection 13 has a first portion 131 having a shape corresponding to the secondary base 12 so as to cooperate with the latter. More specifically, the first portion 131 of the transparent protection 13 has dimensions slightly larger than the secondary base 12 so as to cover the secondary base 12 and wrap the flange 122 at least partially.

The first portion 131 may have, for example at its corners/angels, a locking or blocking means, for example a clip (not illustrated) intended to cooperate with the flange 122 of the secondary base 12 so as to hold the transparent protection 13 in position on the secondary base 12.

A transparent protection 13 intended to cover only one secondary base 12 is herein illustrated. In a non-illustrated variant, one could also contemplate implementing a unique transparent protection that would cover several secondary bases 12. Nonetheless, this unique transparent protection may be shaped so as to individually separate each culinary preparation portion disposed on the secondary bases 12.

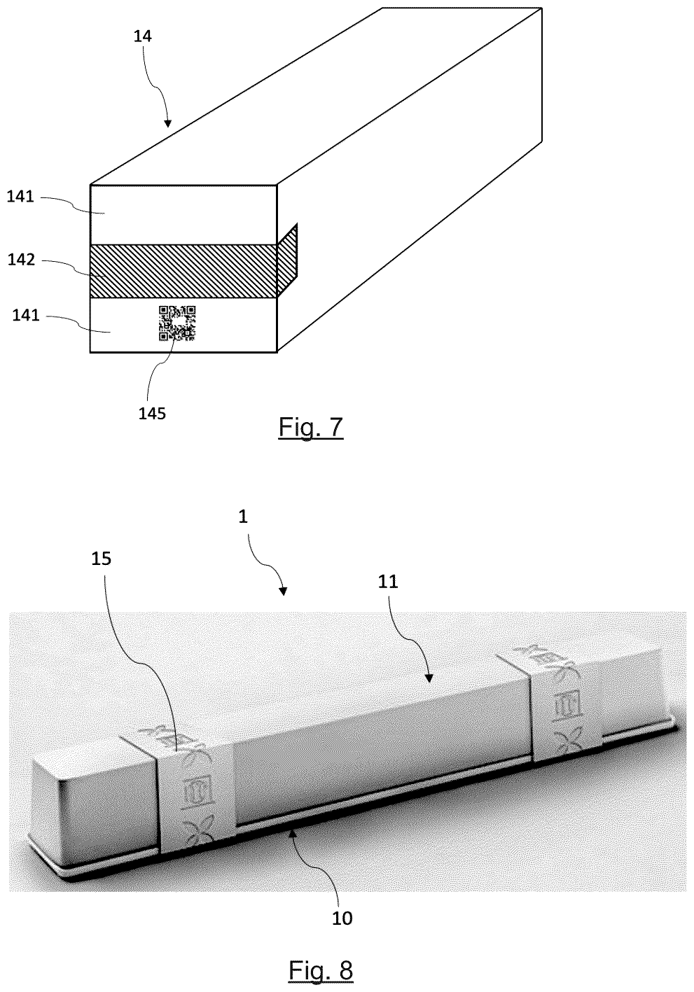

FIGS. 6 and 7 illustrate in perspective an overpackaging 14 into which the packaging 1 is intended to be inserted, by one of the small sides of the formed parallelepiped. More specifically, FIG. 6 illustrates an empty and open overpackaging 14 whereas FIG. 7 illustrates a closed overpackaging 14 into which a packaging 1 containing culinary preparation portions have been inserted beforehand.

Such an overpackaging 14 has a conventional shape, for example a parallelepiped with an open (small-size) end provided with tabs, or flaps, 141 which allow closing the overpackaging 14.

Preferably, the overpackaging is also made of sugar cane pulp, which is a biodegradable and easily recyclable material. Other biodegradable and/or recyclable materials may be used without departing from the principle of the invention.

Thus, once the culinary preparation portions are disposed on the secondary bases 12, each secondary base 12 is covered by the transparent protection 13 and is placed/disposed on the main base 10 which is then covered by the cover 11.

Optionally, a holding bracelet (not illustrated) may be implemented in order to hold the cover 11 on the main base 10. For example, this holding bracelet may surround the cover 11 and the main base 10 in order to prevent an undesired opening of the packaging, in particular during transport or during heat-up. Preferably, such a holding bracelet is made of a material withstanding high temperatures and very low temperatures, as described hereinabove. Preferably, the holding bracelet is also made of an elastic material in order to facilitate the installation and removal thereof on the packaging 1.

Afterwards, the packaging 1 could be inserted into the overpackaging 14 to promote storage and transport thereof. The overpackaging 14 also allows facilitating presentation and arrangement, for example on the shelves of a culinary preparation retail shop, a hotel, an airplane . . . .

Each overpackaging 14 may be provided with an identification code 145 relating to the packaging 1 and to the culinary preparations contained thereby. This code 145 may be identical to the code 115 borne by the cover 11 of the packaging 1 and described before. For example, the identification code 145 may be affixed on one of the tabs 141 of the overpackaging 14, so that it is visible when the overpackagings are stacked during storage, transport or placement on the shelves. Other positions of the identification code 145 on the overpackaging may be contemplated without departing from the principle of the invention.

As illustrated in FIG. 7, a securing ring 142 is implemented in order to seal the overpackaging 14. In this example, the securing ring is in the form of an adhesive tape placed on the junction of the tabs 141 of the overpackaging 14. Other shapes of securing rings may be contemplated without departing from the principle of the invention.

This securing ring 142 allows avoiding an undesired opening of the overpackaging 14, in particular, so as to guarantee a good traceability of the culinary preparations stored in the packaging 1.

FIG. 8 illustrates an example of a packaging according to the invention wherein the cover 11 is disposed on the main base 10. It should be understood that a plurality of secondary bases 12 and of transparent protections 13 are disposed inside the cover 11, on the main base 10. It should be noted that, in this example, the packaging 1 has two securing collars 15 which allow holding the cover 11 in position on the main base 10. Such securing collars allow avoiding any undesired opening of the packaging.

For example, these securing collars 15 may be ornamented and/or bear a logo or any advertisement type. The same applies to the overpackaging 14 described before.

1. A packaging for storage and presentation of culinary preparations in the form of a series of unit portions, wherein the packaging comprises:
a main base made of a biodegradable material based on sugar cane pulp, having a first bottom and a first flange extending from a periphery of said first bottom;
a plurality of secondary bases to be placed in said main base and each adapted to receive one of said unit portions, made of a biodegradable material based on sugar cane pulp and each having a second bottom and a second flange extending from a periphery of said second bottom, at least said second bottom being covered with a tight biodegradable coating; and
a cover for protection and storage of the culinary preparation portions, adapted to fit onto said main base;
dimensions of said main base and of said cover being defined so that they could receive said plurality of secondary bases according to a unique line.

2. The packaging according to claim 1, wherein said cover has a truncated pyramid shape.

3. The packaging according to claim 1, wherein the packaging comprises a plurality transparent protections made of a biodegradable material, each of said protections fitting into one of said secondary bases.

4. The packaging according to claim 1, wherein said tight biodegradable coating is recycled polyethylene terephthalate (RPET).

5. The packaging according to claim 1, wherein the first bottom of said main base and the second bottoms of said secondary bases are substantially rectangular or square.

6. The packaging according to claim 1, wherein the packaging bears a unique identification code of said culinary preparation(s) stored and presented in said packaging.

7. The packaging according to claim 6, wherein said identification code and/or a second code are configured in the form of an image readable and interpretable by a suitable electronic device, to enable obtainment of information relating to the culinary preparation portion(s) stored and presented in said packaging.

8. (canceled)

9. The packaging (1) according to claim 1, wherein the packaging comprises a rectangular parallelepipedic overpackaging into which the packaging is to be inserted and extracted by one of the small sides of the parallelepipedic overpackaging.

10. The packaging according to claim 9, wherein said overpackaging is sealed by a single-use securing element proving that the packaging has not been opened.

11. The packaging according to claim 1, wherein said cover comprises at least one stop configured to enable a controlled stacking of several covers for storage thereof.

12. (canceled)
